(19) United States
(12) Patent Application Publication
(10) Pub. No.: US 2014/0317645 A1
(43) Pub. Date: Oct. 23, 2014

(54) Television Relay for a Social Network

(71) Applicant: LIVERELAY, INC., San Diego, CA (US)

(72) Inventors: KaYeung Cheung, San Diego, CA (US); Long Chain Lee, San Diego, CA (US); Steven Lee Shen, San Marcos, CA (US)

(73) Assignee: LIVERELAY, INC., San Diego, CA (US)

(21) Appl. No.: 13/867,921

(22) Filed: Apr. 22, 2013

(51) Int. Cl. H04N 21/2668; H04N 21/472; H04N 21/4627; H04N 21/442; H04N 21/4784

(52) U.S. Cl. CPC H04N 21/2668; H04N 21/44218; H04N 21/4784; H04N 21/4627; H04N 21/47202
USPC 725/10; 725/93; 725/27; 725/23

(57) ABSTRACT

The subject matter described herein relates to transmitting and displaying a channel of a television to a non-subscriber when a subscriber is viewing the channel so that both the non-subscriber and the subscriber can simultaneously view the channel. A channel is displayed to a subscriber of a service offering the channel. A presence status of the subscriber is monitored. The presence status characterizes a subscriber presence for viewing the channel. The presence status is displayed to one or more contacts of the subscriber, including the non-subscriber. The channel can be simultaneously displayed to the subscriber and the contacts of the subscriber for as long as the subscriber views the channel until a predetermined period of time. Related methods, apparatuses, systems, techniques and articles are also described.

### TECHNICAL FIELD

The subject matter described herein relates to transmitting and displaying a channel of content network to a non-subscriber when a subscriber is viewing the channel so that both the non-subscriber and the subscriber can simultaneously view the content of the displayed channel.

### BACKGROUND

Conventional television service networks include a number of available television channels that can be broadcast to a large number of individuals. Ordinarily, an individual can view some of the broadcasted channels only if the individual is subscribed to those channels. The individuals that do not subscribe to those channels have limited and ineffective options to preview any of the channels. Thus, most individuals that do not subscribe to one or more of those channels continue to be disinterested in those channels, and accordingly, are non-committal about subscribing to any of those channels requiring a channel subscription. As a result, the service providers lose or minimize revenue that can be generated by making the non-subscribers interested in and purchasing those additional channels requiring a subscription. Additionally, conventional television broadcasting service is not designed for social networking features.

### SUMMARY

The subject matter described herein relates to transmitting and displaying a channel of a television to a non-subscriber when a subscriber is viewing the channel so that both the non-subscriber and the subscriber can simultaneously view the channel. A channel is displayed to a subscriber of a service offering the channel. A presence status of the subscriber is monitored. The presence status characterizes a subscriber presence for viewing the channel. The presence status is displayed to one or more contacts of the subscriber, including the non-subscriber. The channel can be simultaneously displayed to the subscriber and the contacts of the subscriber for as long as the subscriber views the channel until a predetermined period of time. Related methods, apparatuses, systems, techniques and articles are also described.

In one aspect, a content server can provide content of a video channel to a first user via a communication network. A management system connected to the content server can receive a request for the content of the video channel from a second user. The content server can provide the content of the video channel to the second user when the first user and the second user are determined to be associated as contacts or friends in a social network. The content of the video channel can be provided to the second user until the content of the video channel is no longer provided to the first user.

In some variations, one or more of the following can be optionally included. The management system can prevent the content of the video channel from the content server from being provided to the second user based on real-time changes to a status of what the first user is currently watching and how long the second user has been watching the content of the video channel. The management system can establish a communication between the first user and the second user when the content of the video channel is being provided to the first user and the second user at substantially the same time. The video channel can include pre-programmed video content.

In another aspect, a video channel can be transmitted to a first display device associated with a first subscriber of a service offering the video channel. A presence status of the first subscriber can be monitored via the first display device. The presence status can characterize a status of the first subscriber relative to the transmitted video channel. The presence status can be transmitted to second display devices associated with one or more contacts of the first subscriber. The one or more contacts can include at least one non-subscriber to the video channel. Transmission of the video channel to the second display devices associated with the one or more contacts of the first subscriber can be established. The transmission to the one or more contacts of the first subscriber can be simultaneous to the transmission of the video channel to the first subscriber. Transmission of the video channel to the second display device associated with the at least one non-subscriber to the video channel can be stopped. A video channel purchase control can be provided to the second display device associated with the at least one non-subscriber. The video channel purchase control can enable the non-subscriber to subscribe to the service offering the video channel.

In some variations, one or more of the following can be optionally included. The one or more contacts can be online in a social network. A communication between the subscriber and the at least one non-subscriber can be enabled when the video channel is being transmitted to the subscriber and the at least one non-subscriber. Transmitting of the video channel to the subscriber and the at least one non-subscriber can be synchronized. The at least one non-subscriber can be a contact with the subscriber via the social network. The presence status can characterize at least one of the following activities associated with the subscriber: viewing the video channel, not viewing the video channel for less than a threshold value of time, not viewing the video channel for more than the threshold value of time, and viewing another video channel.

In yet another aspect, a first request can be received from a subscriber for access to a video channel from a display device via a communication network. A group view token can be generated for the subscriber in response to the first request. The group view token can characterize information related to the channel being watched. The group view token can include an identifier of the video channel or content of the video channel, and a location where the video channel or content is stored. The group view token can be disseminated to one or more social network contacts of the subscriber via the communications network. The one or more social network contacts can include at least one non-subscriber. A second request can be received from the at least one non-subscriber for access to the video channel. The request including the group view token can be generated from the first request from the subscriber. The video channel or content of the video channel, and the location where the video channel or content is stored can be determined via the group view token. Access to the location and content of the video channel by the non-subscriber can be enabled.

In some variations, one or more of the following can be optionally included. Access of the video channel may not be provided to the non-subscriber when the subscriber is not being transmitted the video channel for more than a threshold time. The non-subscriber can be provided an option to subscribe to the video channel when the access to the video channel is not provided to the non-subscriber. The access of the video channel by the non-subscriber can be restored when the non-subscriber uses the option to subscribe to the video channel. The video channel can be transmitted simultaneously to the subscriber and the non-subscriber. A communication between the subscriber and the non-subscriber can be facilitated when the channel is being displayed to the subscriber and the non-subscriber. The video channel can be a television channel.

In another aspect, a system is described that can include a set top box, a management system, and a content server. The set top box can be implemented at a location of a user. The set top box can execute a client software application including one or more content libraries, a content-stream receiving component, a social user component, and an account management component. The content-stream receiving component can receive the content from the content libraries for play-back. The social user component can determine a presence status of a user based on a viewing of the channel by the user. The social user component can determine a subscription status characterizing whether the user is a subscriber. The social user component can further determine a social network characterizing one or more social networking contacts of the user. The account management component can receive authentication data from the user.

The management system can include a communication server and an account management server. The communication server can receive the presence status and the subscription status from the social user component. The account management server can receive the social network from the social user component, and can receive the authentication data from the account management component.

The content server can relay content of the channel to the one or more content libraries based on the authentication data, the presence status, the subscription status, and the social network. The relayed content of the channel can be displayed to the user.

In some variations, one or more of the following can be implemented. The client software application on the set top box can be connected to the management system via a first network. The client software application on the set top box can be connected to the one or more content servers via a second network. The one or more content servers can be connected to the management system via a third network. The first network and the second network can be internet. The third network can be intranet.

The management system and the content server can be implemented on separate computers. The communication server and the account management server can be implemented on a same computer. The communication server and the account management server can be implemented on separate computers. The communication server can execute based on an extensible messaging and presence protocol (XMPP) protocol for communicating with the social user component. The account management server can execute a representational state transfer (REST) software architecture that can use a hypertext transfer protocol secure (HTTPS) protocol. The client software application can be provided to the user via a graphical user interface that can receive the authentication data from the user and can display the content of the channel to the user.

The displayed content of the channel can include a plurality of channels that can be ordered based on at least one of one or more preferences of the user and social interactivity of the user with the one or more social networking contacts. The social user component can continuously determine the presence status of the user. The user can be a subscriber.

The content server can transmit the content to the subscriber and one or more non-subscribers that are contacts of the subscriber when the presence status indicates that the subscriber is viewing the channel. The content can be transmitted and displayed simultaneously to the subscriber and the one or more non-subscribers. The content server can stop transmitting the content to the non-subscribers when the presence status indicates that the subscriber is not viewing the channel.

The system can further include a remote control device. The remote control device can facilitate communication between the subscriber and the one or more non-subscribers. The remote control device can include a receiver of a microphone, a voice to text converter, and a transmitter of the microphone. The receiver of the microphone can receive voice signals of the subscriber during the communication. The voice to text converter can convert at least a portion of the voice signals of the subscriber into corresponding text signals. The transmitter of the microphone can send the text signals to the communication server that sends the text signals to the one or more non-subscribers. The text signals sent to the one or more non-subscribers can be displayed on at least one of: a webpage accessible to the one or more non-subscribers, and a graphical user interface of a client application executed on a set top box at a location of each of the one or more non-subscribers.

The remote control device can further include a social button that can allow the user to toggle between a full screen viewing mode and a friends mode. The full screen viewing mode can display the content of the channel on a full screen. The friends mode can display the content of the channel and a list of contacts of the user that are viewing the content displayed to the user.

Computer program products are also described that comprise non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the system described herein allows a non-subscriber to view a channel if a social network contact of the non-subscriber has a subscription to the content-streaming service providing the channel and if the social network contact is viewing the channel. This viewing of a channel without the non-subscriber immediately purchasing the subscription can encourage the non-subscriber to subsequently purchase the subscription, thereby increasing the revenue and profits of a business entity providing the content streaming service. The system provider can manage rights and license of the content or channel so that the non-subscriber can view the content during the preview period. The system also allows distantly living friends and/or families to reunite by simultaneously and separately viewing shows and/or events (for example, sports games, political debates, cooking shows, music videos, news shows, and any other show or event) on channels that they like while interacting with each other in a virtual living room. Moreover, the social networking aspect allows users to find new content and channels based on common interests, and stay in touch with contacts having similar interests.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a system for a relay and display of a channel based on a social network;

FIG. 2 is a system diagram illustrating a system for a relay and display of a channel based on a social network;

FIG. 3 is a system diagram illustrating a system for a relay and display of a channel based on a social network;

FIG. 4 is a flow diagram illustrating a method of relaying and displaying a channel to a non-subscriber when a subscriber is viewing the channel;

FIG. 5 is a flow diagram illustrating a first sequence of steps performed to simultaneously display the channel to different users and allow a communication between those users;

FIG. 6 is a flow diagram illustrating a second sequence of steps performed to simultaneously display the channel to different users and allow a communication between those users;

FIG. 7 is a flow diagram illustrating a third sequence of steps performed to simultaneously display the channel to different users and allow a communication between those users;

FIG. 8 is a flow diagram illustrating a fourth sequence of steps performed to simultaneously display the channel to different users and allow a communication between those users;

FIG. 9 is a diagram illustrating a first graphical user interface that allows a group-watch of a channel by different users in a virtual living room;

FIG. 10 is a diagram illustrating a second graphic user interface that allows group-watch of a channel by different users in a virtual living room;

FIG. 11 is a diagram illustrating a third graphic user interface that allows a group-watch of a channel by different users in a virtual living room;

FIG. 12 is a diagram illustrating a third graphic user interface that allows a group-watch of a channel by different users in a virtual living room; and

FIG. 13 is a diagram illustrating a third graphic user interface that displays channels available for a user.

Like reference symbols in the various drawings indicate like elements.

### DETAILED DESCRIPTION

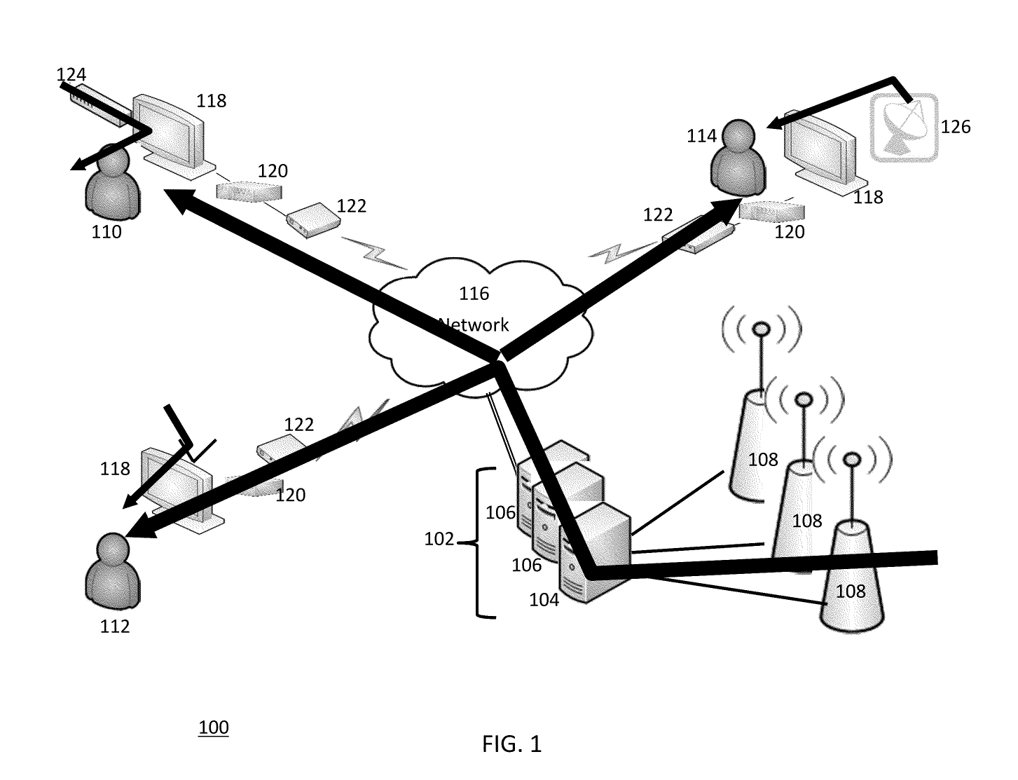

FIG. 1 is a diagram illustrating a system 100 for a relay and display of a channel based on a social network. The channel is a television channel. While the channel is described as a television channel, other channels are possible, such as a movie, an internet channel, a radio channel, a multimedia channel, and other channels. The social network is a network of contacts (also referred to as connections, friends, associates, colleagues, followers, mentors, mentees, and/or the like) connected on a social networking application executed over a communication network, such as internet, local area network, wide area network, metropolitan area network, or any other network.

One or more server computers 102 are implemented at a server station. The server computers 102 include a content server 104 and a management system 106. The content server 104 can include one or more computers, and the management system can include one or more computers. The content server 104 receives content of a channel from a third party, such as a business entity that desires to distribute its channel. The content of the channel can be received at base stations 108 via a direct connection, such as via ethernet, serial digital interface (SDI), asynchronous serial interface (ASI), high definition multimedia interface (HDMI) or other connections. In other implementations, the content of the channel can be received at base stations 108 via a communication network, such as a satellite downlink, internet, intranet, local area network, wide area network, Bluetooth network, infrared network, or any other network.

The content server 106 transmits and provides the content of the channel to subscribers 110 and 112. The content server 106 relays the content of the channel to a non-subscriber 114 if the non-subscribers is a contact of at least one subscriber 110 or 112 on a social network, wherein such a relay occurs for only a time-period for which the connected subscriber 110 or 112 is viewing (also referred to as accessing or watching) the channel. The social network is created and managed by the management system 106, wherein social network contacts can be added and deleted by each user. Although the social network is described to be created and managed by the management server 106, other implementations using a third party social network are also possible, wherein the third party social network can be one of FACEBOOK, LINKEDIN, TWITTER, or any other social network. The content of the television channel can be transmitted to the subscribers and associated non-subscribers over a communication network 116, such as the internet. Although internet has been described, other communication networks can also be used, such as intranet, local area network, wide area network, Bluetooth network, infrared network, or any other network.

For the transmission and relay of the content to users, which include the subscribers 110 and 112, and the non-subscriber 114, a user device 118 is implemented at a location of each user. For example, the user device 118 can be placed at a home of each user. The user device 118 includes a graphic user interface that displays a channel to the user, and an input device (for example, a remote control apparatus with a keypad for input) that receives input data from the user. The user device 118 can be a television set, such as a smart television set. Although a television set is described, other user devices can alternately be implemented, such as a computer, a tablet computer, and other devices that have display capabilities. Each user device 118 is connected, via a wire or wirelessly, with a set top box 120. The set top box 120 can be placed next to the user device 118 in the home of the user. The set top box 120 is connected, either via a wire or wirelessly, with an internet modem 122 that enables communication between a corresponding user (110, 112, or 114) and the servers 102.

Although a set top box 120 is described herein, in some other implementations, a set top box may not be required. For example, there can be an end-user software application that can be executed on a user device (for example, a smart television) that can provide functionality in lieu of the physical set top box 120.

While the user device 118 is connected to the set top box 120 and the internet modem 122, additionally, the user device 118 can optionally be connected to a cable television box 124. In another implementation, the user device 118 can optionally be connected to one of: an internet protocol television (IPTV) box, a receiver (for example, a satellite or any other receiver), and a tuner that allows user to view the displayed content. Such a connection to the cable television box (or other receivers, as noted) allow the user to view cable television (or internet protocol television or other data) as well besides viewing the content of the channel transmitted by the servers 102. Further, the user device 118 can optionally be connected to a satellite system 126 including a satellite transceiver so that the user can view satellite television as well besides viewing the content of the channel transmitted by the servers 102.

As noted above, a channel is displayed to direct or first level contacts (for example, friends) of a subscriber on the social network when the subscriber is viewing the channel. However, other implementations are also possible. For example, in one implementation, the channel can be relayed and displayed to the first level contacts and the second level contacts (for example, friends of friends) of the subscriber on the social network when the subscriber is viewing the channel. In other implementations, the channel can be relayed and displayed to the first level contacts, the second level contacts, and the third level contacts of the subscriber on the social network when the subscriber is viewing the channel. In yet another implementation, the channel can be displayed to the contacts until any level of the subscriber, as determined by a developer of a client software application 302 (described below) implemented on the set top box 120, when the subscriber is viewing the channel.

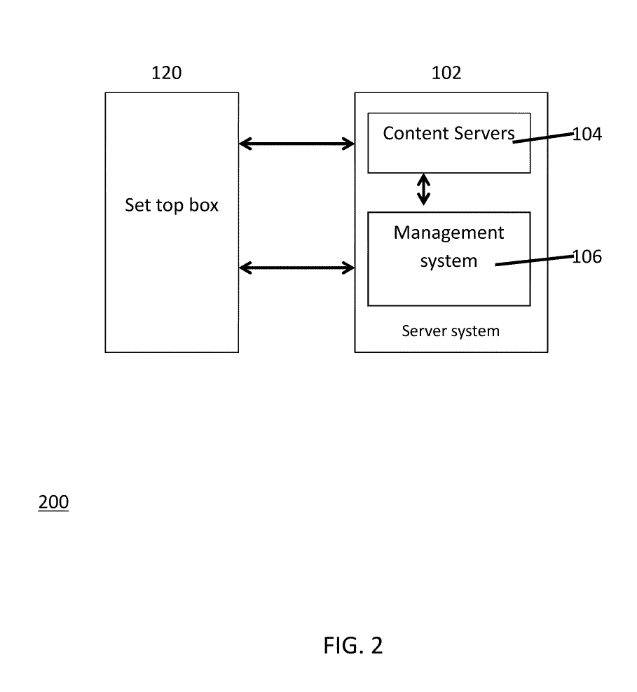

FIG. 2 is a system diagram illustrating a system 200 for a relay and display of a channel based on a social network. The set top box 120 is implemented at a location of a user, which can be either a subscriber or a non-subscriber. The set top box 120 receives content of the channel transmitted from content server 104, and displays the transmitted content to the user. The set top box 120 stores, in a memory, the content of the channel for replaying and rewinding when the user desires. The set top box 120 also receives authentication data from the user, wherein the authentication data can include login information, such as a user name and password, and/or other digital rights access authorization. For a user that has provided accurate authentication data, the set top box 120 determines a presence status of the user based on an access of the channel by the user, a subscription status characterizing whether the user is a subscriber, and a social network characterizing one or more social networking contacts of the user. Alternatively, the function of the set top box 120 can be implemented completely with a software application that is executed on a browser or on any other device.

The management system 106 receives the authentication data from the set top box 120 and validates the user based on the authentication data. For a validated user, the management system 106 receives the presence status from the set top box 120 via the communication network 116. The management system 106 retrieves the subscription status and the social network from a database within the management system 106, wherein this database stores the subscription status and the social network of the user.

Based on the presence status, the subscription status, and the social network, as received at the management system 106, the content server 104 can transmit content of the television channel to the set top box 120. The transmitted content is then displayed to the user on a graphic user interface of the user device 118.

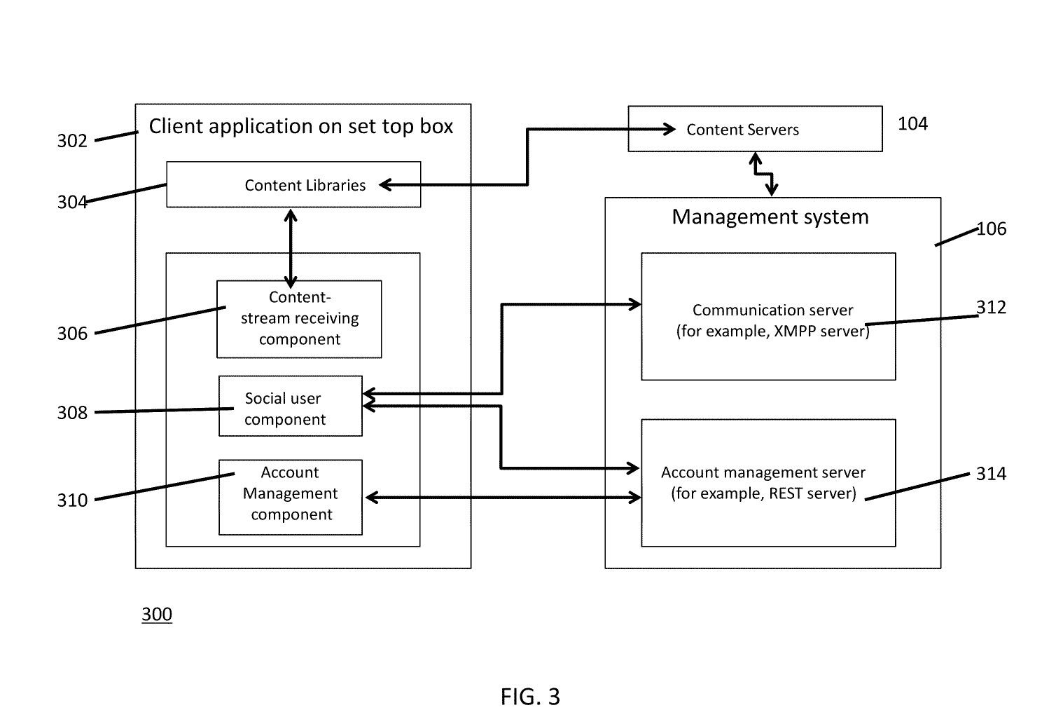

FIG. 3 is a system diagram illustrating a system 300 for a relay and display of a channel based on a social network. A set top box 120 is implemented at a location of a user, such as a home or office of the user. The set top box 120 implements a client software application 302 including one or more content libraries 304 (also referred to as content access provider libraries), a content-stream receiving component 306, a social user component 308, and an account management component 310. The content-stream receiving component 306 receives the content from the content libraries 304 so that the content can be transmitted and provided when the user or a developer of the software application 302 desires. The social user component 308 determines a presence status of the user based on a viewing activity of the channel by the user. The social user component 308 determines a subscription status characterizing whether the user is a subscriber, and a social network characterizing one or more social networking contacts of the user. The account management component 310 receives authentication data from the user, such as login data including a username and a password.

The management system 106 includes a communication server 312 and an account management server 314. The communication server 312 uses an extensible messaging and presence protocol (XMPP) while communicating with the social user component 308. The account management server 314 implements a representational state transfer (REST) software architecture that uses a hypertext transfer protocol secure (HTTPS) protocol. The communication server 312 receives the presence status from the social user component 308. The account management server 314 stores the social network characterizing one or more social networking contacts of the user, provides the information associated with the social network to the social user component 308, and receives the authentication data from the account management component 310. In some other implementations, the communication server 312 can be implemented using architecture other than REST, and/or the account management server 314 can be implemented using architecture other than HTTPS.

The content servers 104 transmit content of the television channel to the one or more content libraries 304 based on the authentication data, the presence status, the subscription status, and the social network. The transmitted content of the television channel is then displayed to the user on a graphic user interface of the user device 118.

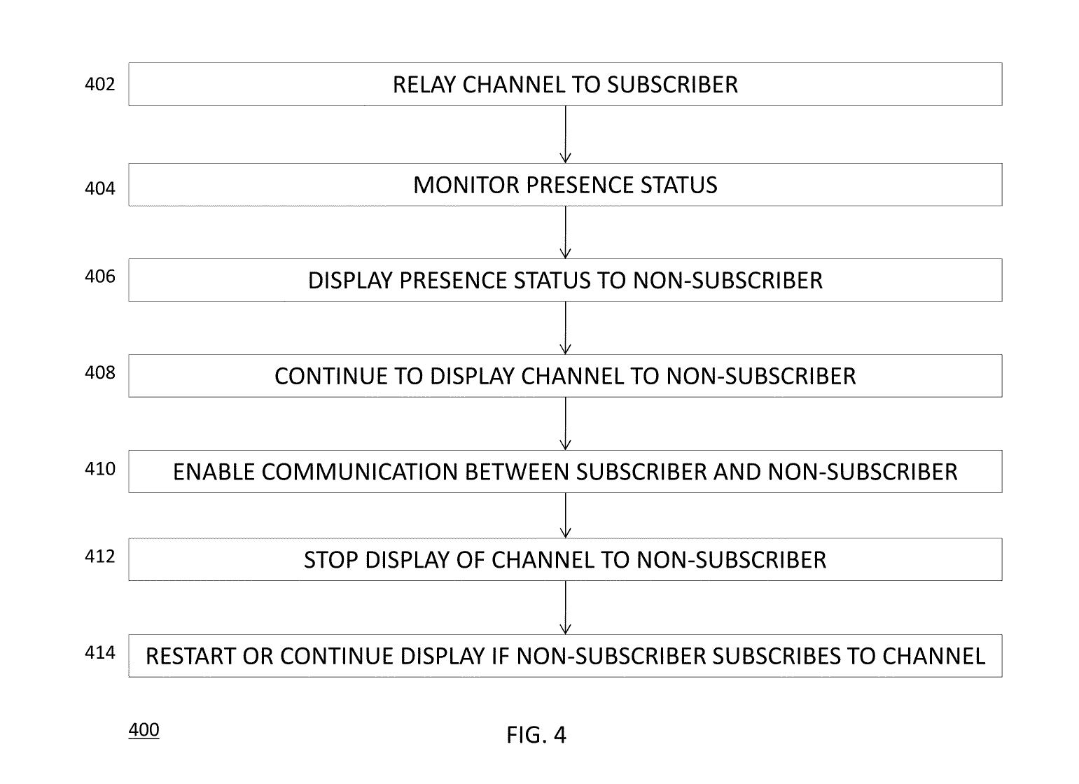

FIG. 4 is a flow diagram illustrating a method 400 of relaying and displaying a channel to a non-subscriber when a subscriber is viewing the channel. At 402, the content provider server 104 transmits a channel to a subscriber (110 or 112) of a service offering the channel. The channel can be transmitted over a communication network 116, such as the internet. The transmitted channel can be displayed to the subscriber (110 or 112) on a graphic user interface of the user device 118 of the subscriber (110 or 112).

At 404, the social user component 308 of the software application 302 monitors a presence status of the subscriber. The presence status characterizes a presence of the subscriber 110 or 112 for viewing the television channel. The presence status characterizes at least one of the following activities of the user: viewing the channel, not viewing the channel for less than a threshold value of time, not viewing the channel for more than the threshold value of time, and viewing another television channel.

At 406, the presence status is displayed to the contacts of the subscriber, who may be either subscribers or non-subscribers of the channel that is being viewed by the subscriber. Thus, if the non-subscriber 114 is a contact of the subscriber, the presence status is displayed to the non-subscriber. For any user, the presence status of all contacts of the user is displayed to the user. With respect to diagram 400, the non-subscriber 114 is assumed to be a contact of the subscriber 110 or 112, and the presence status is displayed on a graphic user interface of the user device 118 of the non-subscriber 114.

The television channel can be displayed to any user, irrespective of the subscription status of the user, for a first predetermined period of time (for example, 10 seconds, 30 seconds, 1 minute, 2 minutes, or any other period of time). After the predetermined period elapses, the transmission and display of the television channel to a non-subscriber can continue only if either a contact of the non-subscriber is a subscriber and is viewing the television channel. At 408, at the first predetermined period of time and when the management system 106 verifies from the presence status that the subscriber is viewing the television channel, the content provider server 104 continues to transmit the channel to the non-subscriber 114 via the communication network 116, such as the internet. The transmitted channel can be displayed to the non-subscriber 114 on a graphic user interface of the user device 118 of the non-subscriber 114.

The subscriber and the one or more non-subscribers are displayed a same content of the channel at all times such that there is no or minimal lag/delay between the displays to different users. For example, when different users are viewing a soccer match, different kicks by players, running movements of the players, goals scored by the players, and all other events in the soccer match are simultaneously displayed with no lag or a minimal lag to all the users. The display of the channel with no or minimal delay is accomplished as follows. The client application 302 of the non-subscriber calculates the delay, and informs about this delay to the content libraries 304 and content stream receiving component 306. The content libraries 304 compensate for the delay so that the channel is displayed synchronously to the subscriber (110 or 112) and the non-subscriber 114.

At 410, communication can be enabled between the subscriber 110 or 112 and the non-subscriber 114 when the television channel is being displayed to the subscriber 112 and the non-subscriber 114. This communication can be one or more of text, voice, video or multimedia communication, as desired by either the subscriber (110 or 112) or the non-subscriber 114.

At 412, the transmission and display of the television channel to the non-subscriber 114 can be stopped at and after a second predetermined period of time (for example, 2 minutes, 5 minutes, 15 minutes, 30 minutes, or any other period of time) passes after the first predetermined time irrespective of whether the non-subscriber 114 is a contact of the subscriber (110 or 112). The server system 102 can stop the transmission and display of the television channel to the non-subscriber 114 when the non-subscriber 114 stops watching the television channel. In another implementation, the server system 102 can stop the transmission and display of the television channel to the non-subscriber 114 when the subscriber (110 or 112) switches to another television channel or turns off the system (for example, turns off his/her set top box). At the second predetermined period of time, the non-subscriber 114 is provided an option to subscribe by performing an action, such as paying, using a coupon, obtaining a credit, or any other suitable action.

At 414, the transmission and display of the television channel to the non-subscriber is continued or restarted if the non-subscriber 114 subscribes to the television channel.

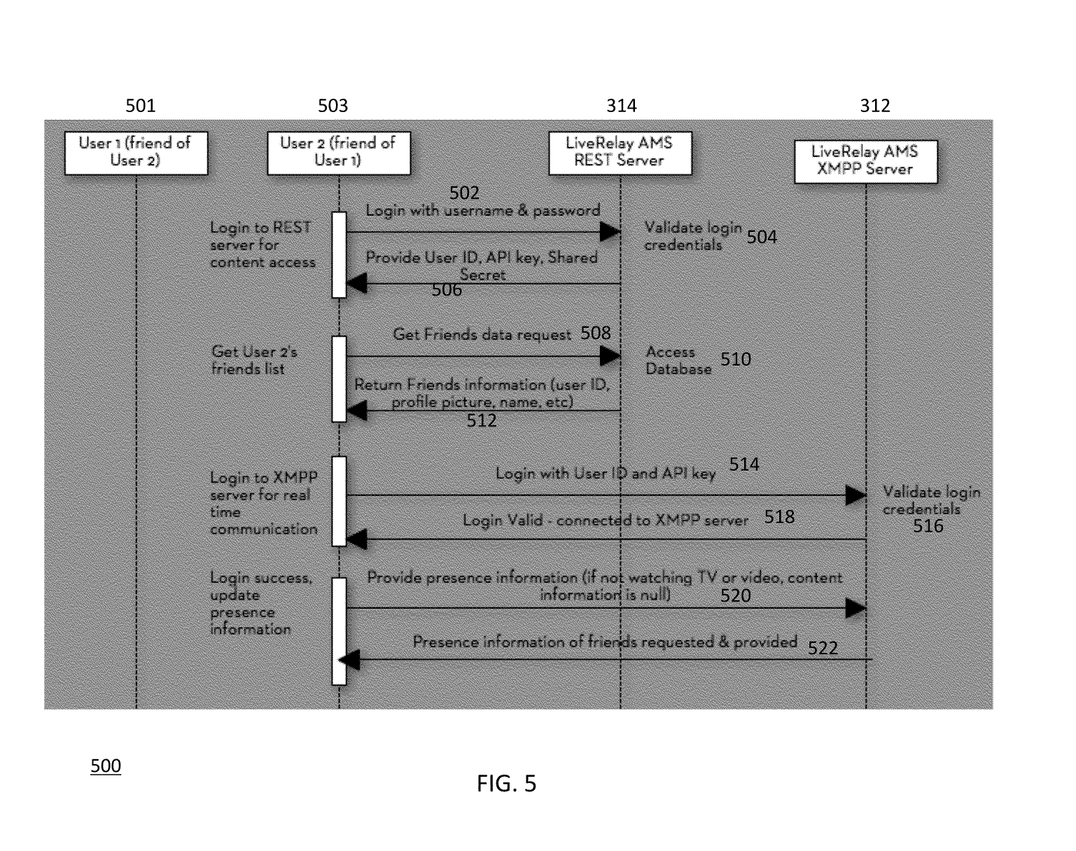

FIG. 5 is a flow diagram 500 illustrating a first sequence of steps performed to simultaneously display the channel to different users and allow a communication between those users. The flow diagrams 500, 600 (described below), 700 (described below) and 800 (described below) collectively show a method of simultaneously displaying the channel to a first user 501 and a second user 503 that is a contact of the first user 501 on the social network, and allowing a communication between the first user 501 and the second user 503.

At 502, the second user 503 logs-in by inputting a username and password on a graphic user interface of the user device 118 of the second user 503. This inputted username and password are sent over the communication network 116 to the account management server 314.

At 504, the account management server 314 validates the username and password of the second user 503.

At 506, if the username and password are determined as valid by the account management server 314, the account management server 314 sends a user identifier, an application programming interface key, and a shared secret key to the client application on the set top box 302 of the second user 503. The shared secret key facilitates identification and authentication of exchange between any of the users and the account management server 314. The shared secret key is generated after initial exchange and is used for encryption and de-encryption during subsequent exchanges in order to ensure that communications is secure. The user identifier and the application programming interface key can be used by the client application 302 of the second user 503 to communicate with 314 to gain access and view any channel desired by the second user 503 if the second user 503 is a subscriber of a service offering various channels. If the second user is not a subscriber, the channel can be displayed to the second user only if a contact of the user on the social network is a subscriber and is viewing the channel.

At 508, the second user 503 requests to view information associated with contacts of the second user 503 on the social network. The contacts can be one or more of: first level contacts, second level contacts, third level contacts, and so on.

At 510, the account management server 314 accesses an associated database to find the contacts of the second user 503. The associated database can be a memory within the account management server 314 such that the access of the database is local. In other implementations, the database can be remote to the account management server 314, and the database can be accessed remotely over a network, such as a local area network, wide area network, internet, or the like.

At 512, the account management server 314 provides a list or tree of social network contacts of the second user 503 to the client application 302 of the second user 503. For example, the account management server 314 sends data associated with the contacts of the second user 503, wherein this data includes a user identifier, profile photograph, name, and any other identifier associated with each contact of the second user 503.

At 514, the second user 503 logs-in to the communication server 312 by inputting, in the client application 302, the user identifier and the application programming interface key.

At 516, the communication server 312 validates the user identifier and the application programming interface key.

At 518, if the user identifier and the application programming interface key are valid, the second user 503 is connected to the communication server 312, and the communication server 312 sends a confirmation of this connection. When both the second user 503 and first user 501 are connected to the communication server 312 and are viewing the same channel, they can communicate with each other. This communication can be one or more of text, voice, and video communication, as desired by either the second user 503 or the first user 501. The text communication can include emoticons, tweets, predefined text such as canned text, third party messages such as FACEBOOK messages, and other possible text communication. The voice communication can include speech, laughter, utterances, hisses, boo's, shouts, and other audio signals other than noise. The video communication can include significant movements of users, such as a jumping movement when a home-run is scored in a baseball match.

A set top box 120 implemented at a location of the second user 503 automatically obtains the second user 503's presence status (indicating whether the user is viewing a channel), and indications of whether the user is scrolling from channel to channel, powered on the device, is powered off the display device, and/or is on a particular menu screen. The presence status is obtained based on current activities of the second user 503. The presence status can be updated with a click on the channel change button on the remote to change the channel. The presence status characterizes at least one of the following activities associated with the second user 503: viewing the television channel, not viewing the channel for less than a threshold value of time, not viewing the channel for more than the threshold value of time, and viewing another television channel.

At 520, the obtained presence is then sent to the communication server 312 via the communication network 116. The presence status of the second user 503 is used to display to the contacts of the second user 503 irrespective of whether the second user 503 is being displayed the channel. In some implementations, the presence status is updated in real-time and displayed in real-time. In other implementations, the presence status can be updated at regular intervals of time, such as every 30 seconds, 1 minute, 2 minutes, 5 minutes, 30 minutes, 1 hour, 2 hours, or any other value of time. In yet other implementations, the presence status can be updated based on an event, such as a click of a button on a remote control device provided to the second user 503.

In some implementations, the first user 501 can be a non-subscriber 114, and the second user 503 can be a subscriber 110 of a service offering the channels. In these implementations, if the second user 503's presence status indicates that the second user 503 is viewing a specific channel for more than a threshold value of time (that is, not channel browsing but watching a particular channel steadily), the channel can be displayed to the contacts of the second user 503. Otherwise, the specific channel that second user 503 is watching is prevented from being displayed to the other users.

At 522, the communication server 312 can send a presence status of social network contacts of the second user 503 along with identifications of the contacts. For example, the communication server 312 sends and displays the presence status of another user who is already watching a particular channel to the second user 503. If that another user is viewing the channel, the second user 503 can decide whether to view the channel along with this another user and/or to communicate with this another user.

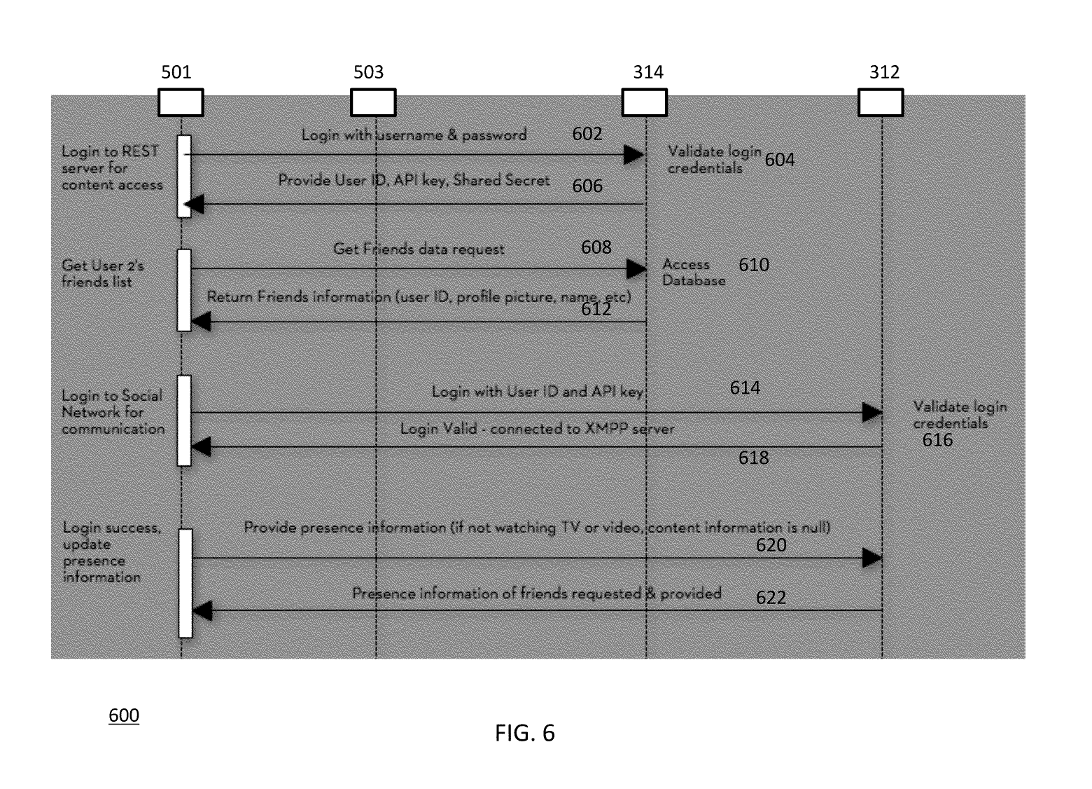

FIG. 6 is a flow diagram 600 illustrating a second sequence of steps performed to simultaneously display the channel to different users and allow a communication between those users. The flow diagrams 500, 600, 700 (described below) and 800 (described below) collectively show a method of simultaneously displaying the channel to different users and allowing a communication between those users.

At 602, the first user 501 logs-in by inputting a username and password on a graphic user interface of the user device 118 of the first user 501. This inputted username and password are sent over the communication network 116 to the account management server 314. At 604, the account management server 314 validates the username and password of the first user 501.

At 606, if the username and password of the first user 501 are determined as valid by the account management server 314, the account management server 314 sends a user identifier, an application programming interface key, and a shared secret key to the client application 302 of the first user 501. The client application 302 of the first user 501 can use the user identifier and the application programming interface key to communicate with the account management server 314 to gain access to and view a channel desired by the first user 501. If the first user 501 is a non-subscriber 114 and the second user 503 is a subscriber 110, the first user 501 can view a particular channel only if the second user 503 is also already and viewing the particular channel. The shared secret key can facilitates identification and authentication of exchange between any of the users and the account management system. The shared secret key can be generated after initial exchange and can be used for encryption and de-encryption during subsequent exchanges in order to ensure that communications is secure.

At 608, the first user 501 requests to view information associated with contacts of the first user 501 on the social network. The contacts can be one or more of: first level contacts, second level contacts, third level contacts, and so on.

At 610, the account management server 314 accesses an associated database to find the contacts of the first user 501. The associated database can be a memory within the account management server 314 such that the access of the database is local. In other implementations, the database can be remote to the account management server 314, and the database can be accessed remotely over a network, such as a local area network, wide area network, internet, or the like.

At 612, the account management server 314 provides a list or tree of contacts of the first user 501 to the first user 501. For example, the account management server 314 sends data associated with the contacts of the first user 501, wherein this data includes a user identifier, profile photograph, name, and any other identifier associated with each contact of the first user 501.

At 614, the first user 501 logs-in to the communication server 312 by inputting the user identifier and the application programming interface key, as received by the user at 606, in the client application 302. At 616, the communication server 312 validates the user identifier and the application programming interface key.

At 618, if the user identifier and the application programming interface key are valid, the first user 501 is connected to the communication server 312, and the communication server 312 sends a confirmation of this connection. When both the first user 501 and the second user 503 are connected to the communication server 312 and are viewing the same channel, they can communicate with each other. This communication can be one or more of text communication, voice communication, and video communication, as desired by either the first user 501 or the second user 503.

A set top box 120 implemented at a location of the first user 501 automatically obtains the first user 501's presence status on a channel. The presence status is obtained based on activities of the first user 501, such as a click on the channel change button on the remote to change the channel. The presence status characterizes at least one of the following activities associated with the first user 501: viewing the television channel, not viewing the channel for less than a threshold value of time, not viewing the channel for more than the threshold value of time, and viewing another television channel.

At 620, the obtained presence is then sent to the communication server 312 via the communication network 116. The presence status of the first user 501 viewing a channel is then displayed and notified to the second user 503. In some implementations, the presence status is updated in real-time and displayed in real-time. In other implementations, the presence status can be updated at regular intervals of time, such as every 30 seconds, 1 minute, 2 minutes, 5 minutes, 30 minutes, 1 hour, 2 hours, or any other value of time.

At 622, the communication server 312 can send a presence status of social network contacts of the first user 501 along with identifications of the contacts. For example, the communication server 312 sends and displays the presence status of the second user 503 for a particular channel to the first user 501. If the second user 503 is viewing a particular channel, the first user 501 can decide whether to view the particular channel along with the second user 503 and/or whether to communicate with the second user 503.

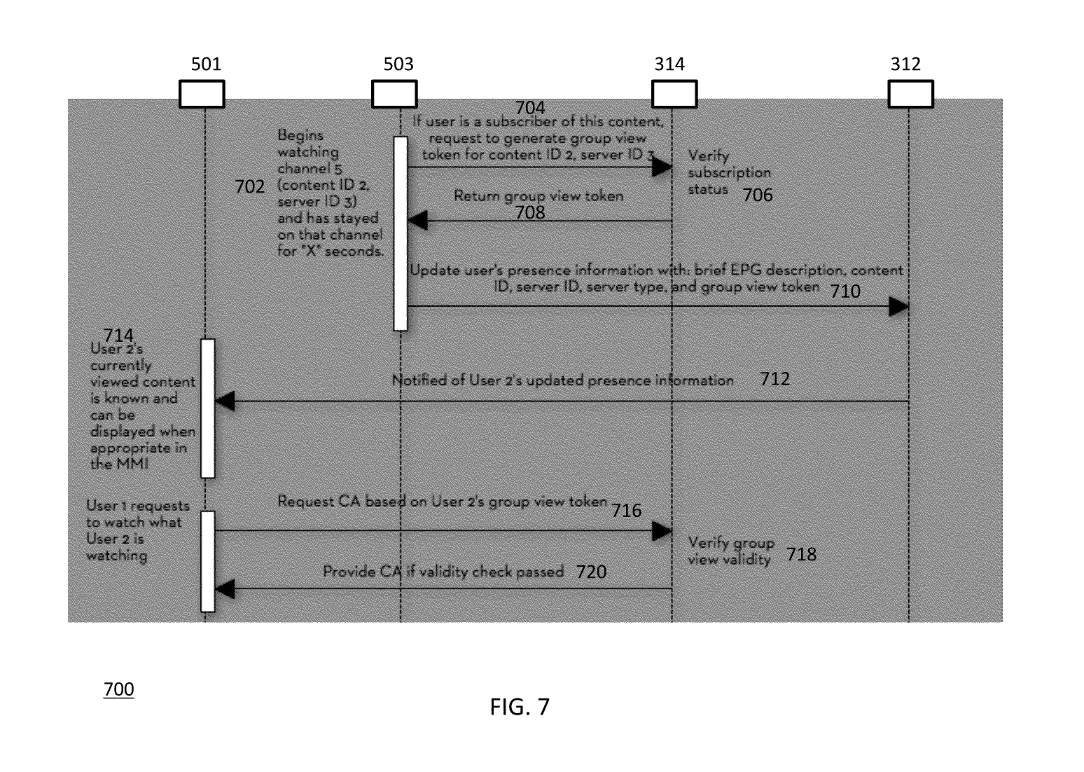

FIG. 7 is a flow diagram 700 illustrating a third sequence of steps performed to simultaneously display the channel to different users and allow a communication between those users. The flow diagrams 500, 600, 700 and 800 (described below) collectively show a method of simultaneously displaying the channel to different users and allowing a communication between those users.

At 702, the second user 503 begins viewing a channel, and continues to view for more than a threshold amount of time (for example, 1 second, 2 seconds, 5 seconds, 20 seconds, 40 seconds, 1 minute, 5 minutes, 30 minutes, or any other amount of time specified by the service provider that offers the channel).

At 704, if the second user 503 is a subscriber of a service offering multiple channels including the channel viewed by the second user 503, the client application of the subscriber sends a request to generate a first group view token to the account management server 314. The group view token includes: identification of the subscriber for whom the group view token is generated, the channel, a number of consumers (for example, contacts of the subscriber) that are allowed to concurrently use the group view token, and a number of consumers for which the group view token is currently activated. In one variation, the group view token can include a server identifier that indicates the location of the server that has stored the content of the channel.

For a consumer to access channel for which the consumer is not subscribed, the following occur. The account management server 314 has a prior knowledge of the group view token associated with the channel that the consumer desires to view. The consumer requests accessing the channel. Subsequently, the client application 302 of the consumer sends a request to the account management server 314. In return, the account management server 314 validates the request by verifying that limits have not been exceeded, that the group view token is still valid, by checking friends relationship, and performing other checks. If the token validation succeeds, the group view token can be delivered to the consumer either through the communication server 312 or through the account management server 314. Along with the group view token, the server can provide playback information (for example, instructions to use the group view token) that the consumer can use to view the content.

At 706, the account management server 314 verifies the subscription status of the second user 503 so as to determine whether the second user 503 is a subscriber. At 708, upon verifying that the second user 503 is a subscriber, the account management server 314 generates and sends a first group view token to the second user 503.

A set top box 120 implemented at a location of the second user 503 automatically obtains the second user 503's presence status on a channel. The presence status is obtained based on activities of the second user 503, such as a click on the channel change button on the remote to change the channel, and any other activity. The presence status characterizes at least one of the following activities associated with the second user 503: viewing the television channel, not viewing the channel for less than a threshold value of time, not viewing the channel for more than the threshold value of time, and viewing another television channel.

At 710, the set top box 120 of the second user 503 sends a presence data of the second user 503 updating the communication server 312 that the second user 503 is viewing a particular channel. The presence data is constantly updated. The updated presence data includes a brief electronic programming guide (EPG) description, the content identifier, the server identifier, and the first group view token.

At 712, the communication server 312 sends the updated presence data of the second user 503 to the first user 501.

At 714, the user device 118 of the first user 501 displays the presence data of the second user. If the presence data of the second user 503 indicates that the second user 503 is viewing the channel, the first user 501 can view the channel if the first user 501 is a contact of second user 503.

At 716, the first user 501 sends a request to the account management server 314 to view the channel that is being viewed by the second user 503. The request is based on the first group view token that was generated and sent to the second user at 708.

At 718, the account management server 314 can determine whether the first group view token of the second user 503 is valid for use by the first user 501. To determine the validity of the first group view token of the second user 503, it is determined whether the first user 501 is a contact to the second user 503 on the social network. If the first user 501 is directly connected to the second user 503 on the social network, the first group token is considered to be valid. Other conditions (for example, whether the limit of allowed concurrent views for this token has been reached) may also determine whether the token is considered to be valid.

At 720, the account management server 314 enables/allows the first user 501 to view the channel when the second user 503 is viewing the channel. When the first user 501 is enabled to view the channel, the one or more content provider servers 104 send the content of the channel on the user device 118 of the first user 501. A graphical interface of the user device 118 displays the content of the channel.

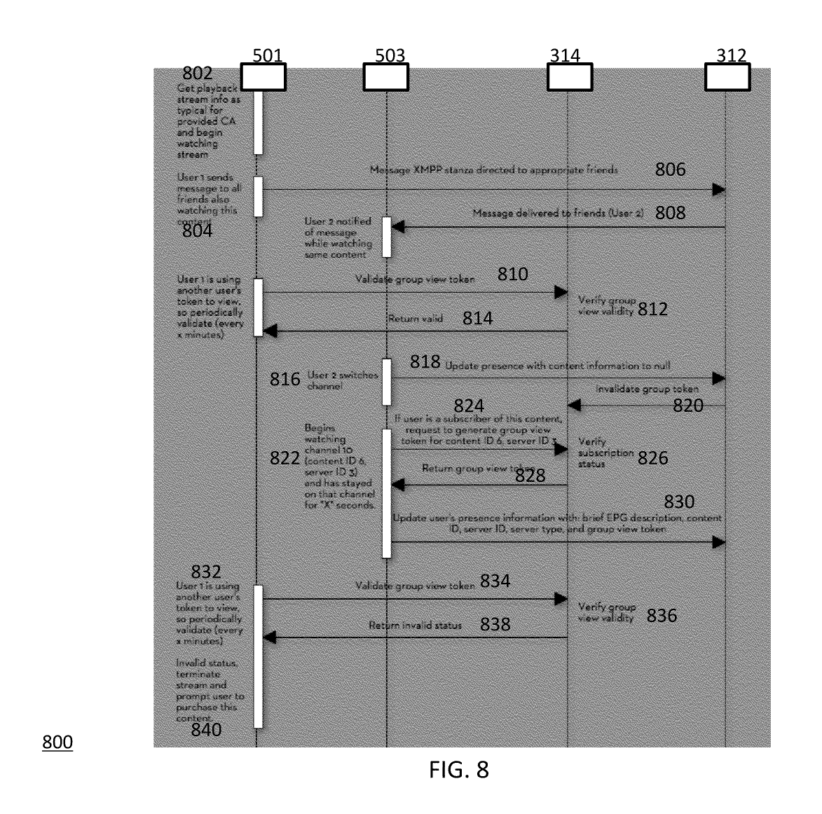

FIG. 8 is a flow diagram 800 illustrating a fourth sequence of steps performed to simultaneously display the channel to different users and allow a communication between those users. The flow diagrams 500, 600, 700 and 800 collectively show a method of simultaneously displaying the channel to different users and allowing a communication between those users.

At 802, the first user 501 receives the playback stream data for the channel from the content provider servers 104, and begins viewing the channel. At 804, the first user 501 enters a message for all contacts in the social network that are also viewing the channel. The message is entered on the graphic user interface of a user device 118 of the first user 501. The message can be entered using a remote control device provided with the set top box 120. Although a remote control device is described as an input device herein, other input devices can also be used, such as a keyboard, a mouse, a joystick, an audio microphone, and/or any other input device. The message can be short and can have an upper limit, such as 50 words, 75 words, 100 words, 120 words, 140 words, 200 words, or any other number.

At 806, the set top box 120 of the first user 501 sends the message to the communication server 312. At 808, the communication server 312 sends the message to all or any specific one of the contacts of the first user 501, including the second user 503 as selected by first user 501. At 810, the first user 501 sends a first group view token of the second user 503 to the account management server 314 so as to validate the first group view token for continuing to view the channel.

At 812, the account management server 314 verifies whether the first user 501 is connected to the second user 503 in the social network. If the first user 501 is connected to the second user 503 in the social network, the account management server 314 can enable the non-subscribing first user 501 to view the channel when the subscribing second user 502 views the channel.

At 814, the account management server 314 sends a confirmation message to the set top box 120 of the first user 501. The confirmation message characterizes that the subscribing second user 502 is viewing the channel and that the first user 501 is connected to the second user 502 on the social network. Subsequently, the set top box 120 facilitates a display of the channel on the graphical user interface of the user device 118 of the second user 502.

At 816, the subscribing second user 503 stops viewing the channel. The presence status of the second user 503 changes from viewing the channel to not viewing the channel. At 818, the updated presence status of the second user 503 is sent to the communication server 312. At 820, the communication server 312 sends a message to the account management server 314, the message requesting to invalidate the first group token associated with the channel.

In addition to the subscribed user leaving the current channel, there can be alternate or additional other cases of invalidation, such as one or more of: user logging out from the server, disconnection from the server due to network unavailability, a simultaneous login from another device, and any other feasible condition. Specifically, invalidation of a group view token can occur as a result of the subscriber logging out from the communication (XMPP) server, logging out of the account management server, being disconnected from the communication server (due to network connectivity interruption), logging into the XMPP server on the same account from another device, and/or any other condition.

At 822, the second user begins viewing a second channel, and continues to view for more than a threshold amount of time (for example, 1 second, 2 seconds, 5 seconds, 20 seconds, 40 seconds, 1 minute, 5 minutes, 30 minutes, or any other amount of time specified by the service provider that offers the channel). The second channel is associated with a content identifier and a server identifier. The content identifier identifies the channel, and the server identifier identifies the location of the server that has stored the content.

At 824, the subscribing second user 824 sends a request to the account management server 314, the request requesting a second group view token to be generated for the second channel. At 826, the subscription status of the second user 824 is verified to determine that the second user is subscribed to the service offering the second channel. At 828, the second group view token for the second channel and the second user 503 is generated and sent to the second user 503.

At 830, the set top box 120 of the second user 503 determines a presence status of the second user 503, and sends presence data to the communication server 312. The presence data is constantly updated. The updated presence data includes a brief electronic programming guide (EPG) description, the content identifier, the server identifier, and the second group view token.

At 832, the non-subscribing first user 501 continues to use the first (that is, old) group view token for the channel that was viewed by the second user 503 before viewing the second channel. At 834, the first user 832 sends a request to the account management server 314 to validate the first group view token for the first user 501. At 836, the account management server 314 verifies a validity of a group view. This validity is not verified, as the first group view token was invalidated, as noted above at 820.

The non-subscriber's video stream can be terminated by a group view token polling validation mechanism. In one implementation, the termination of the non-subscriber's video stream can be initiated by a server. This initiation by the server is not dependent upon the client device to periodically validate the token. In this method, the server may detect that a group view token has been invalidated and may directly terminate any video streams which were delivered as a result of the group view token.

At 838, the account management server 314 sends an invalid status to the first user 501. The invalid status characterizes that the first group view token is invalid and the first user 501 needs a new token to continue viewing the channel or needs to subscribe to the service so as to continue viewing the channel. At 840, the invalid status terminates the display of content of the channel to the first user 501, and displays a message to the first user 501. In another implementation, the termination of viewing (as described in the implementation of ‘invalid status’ above) can be implemented by a cease order given by the communication server 312 or the account management server 314 to the first user 501. The displayed message prompts the first user 501 to purchase the service so as to continue viewing the channel.

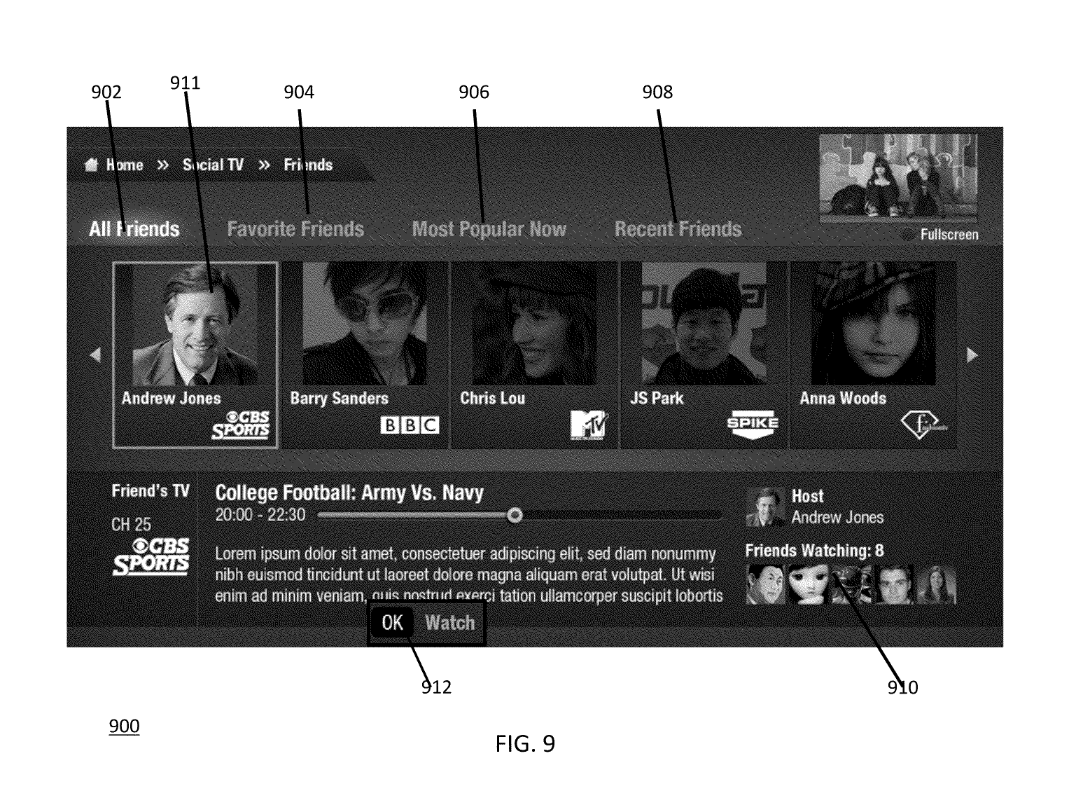

FIG. 9 is a diagram illustrating a first graphical user interface 900 that allows a group-watch of a channel by different users in a virtual living room. Group-watch characterizes a simultaneously view of a channel by different users in a group and an interaction between those users. Group-watch allows social network contacts to interact with each other conveniently and intuitively, as further explained below. Two or more users can interact with each other simultaneously, thereby forming a virtual living room where people can view a same channel and discuss about the viewed channel.

On the graphical user interface 900, icons of contacts of a user are displayed. When the user clicks on a contact's icon, the user is immediately displayed the electronic programming guide (EPG) of the channel being viewed by the contact. When the user clicks an “All Friends” button 902 on the graphical user interface 900, the graphical user interface 900 can display a list of contacts of the user. When the user clicks the “Favorite Friends” button 904, the user can be enabled to create and/or access one or more favorite contacts. When the user clicks the “Recent Friends” button 908, the graphical user interface 900 can display the recent friends of the user. One or more of these buttons 902, 904, 906, and 908 can also be provided on a remote control device provided to the user along with the set top box 120. An icon of each contact can display a name and photo (or other one or more identifiers) of the contact, the channel viewed by the contact, and the presence status of the contact for the channel. The user can select (by clicking) an icon of a contact with whom the user wants to simultaneously view the content being currently viewed by the contact, and then communicate (for example, text chat, talk, and/or video chat) in a separate menu interface. Also, when the user selects the icon, the portion 910 of the graphical user interface 900 can display a number of contacts that are viewing the channel together with the selected contact. For example, when the user selects the icon 911 for contact “Andrew Jones,” the portion 910 of the graphical user interface 900 displays the contacts of “Andrew Jones” that are viewing the channel together with “Andrew Jones.”

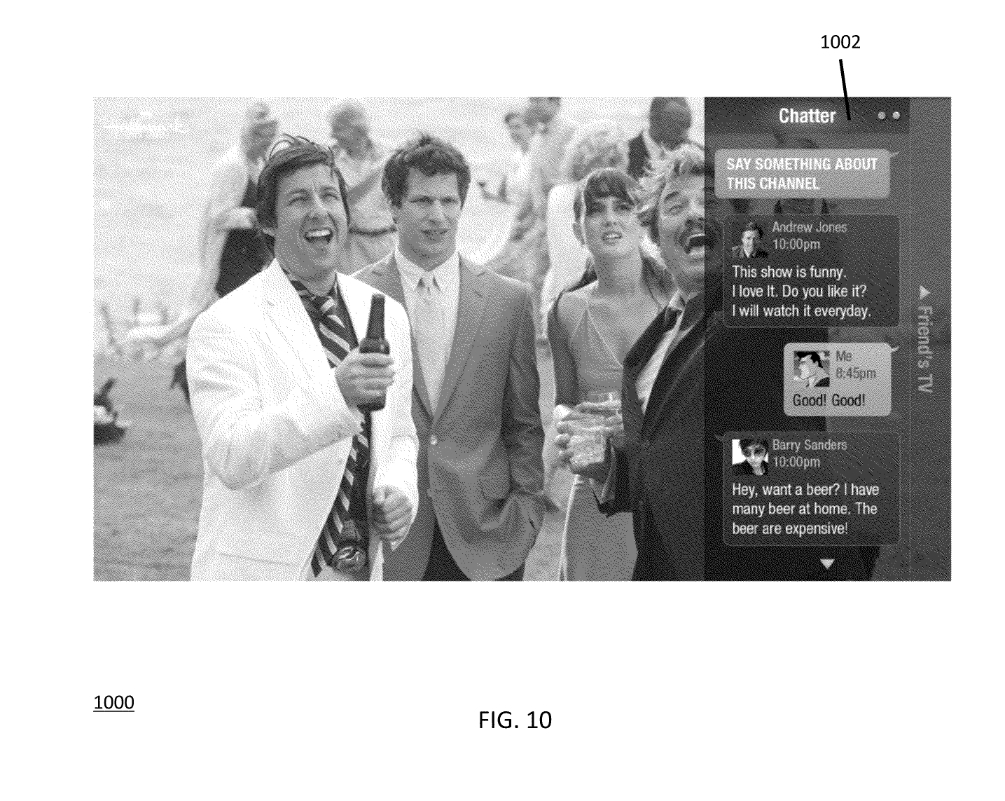

FIG. 10 is a diagram illustrating a second graphic user interface 1000 that allows group-watch of a channel by different users in a virtual living room. When a user's input is pointing on the icon 911 for the contact “Andrew Jones,” the user is provided an OK button 912 (shown in diagram 900) that the user can click to view the channel viewed by the contact “Andrew Jones.” The channel viewed by the contact “Andrew Jones” can be displayed on the graphic user interface 1000. The graphic user interface 1000 displays a chat window 1002 that allows the user to chat with other contacts of the user that are viewing the selected channel that is being viewed by the contact “Andrew Jones.” The chat window 1002 can display a history of chat of a user with the contact “Andrew Jones” or with any other desired particular contact. The user is provided an option to chat in at least one of multiple available languages. During the chat, the user is also provided an option to use emoticons and symbols. To interact with the contacts, the user can input messages via the remote control device associated with the user device 118 of the user. Although a textual chat is described, an audio and/or video chat is also possible. To provide input in an audio chat, the user can input voice via a microphone embedded in the remote control device or via a separate microphone/speaker conferencing system provided to the user. To provide input in a video chat, the user can input video via a camera embedded in the remote control device or a camera connected to the set top box 120 provided to the user. While the microphone and/or the camera are described as being embedded in the remote control device, in some other implementations, the microphone and/or the camera can also be externally attached to the user device 118 of the user.

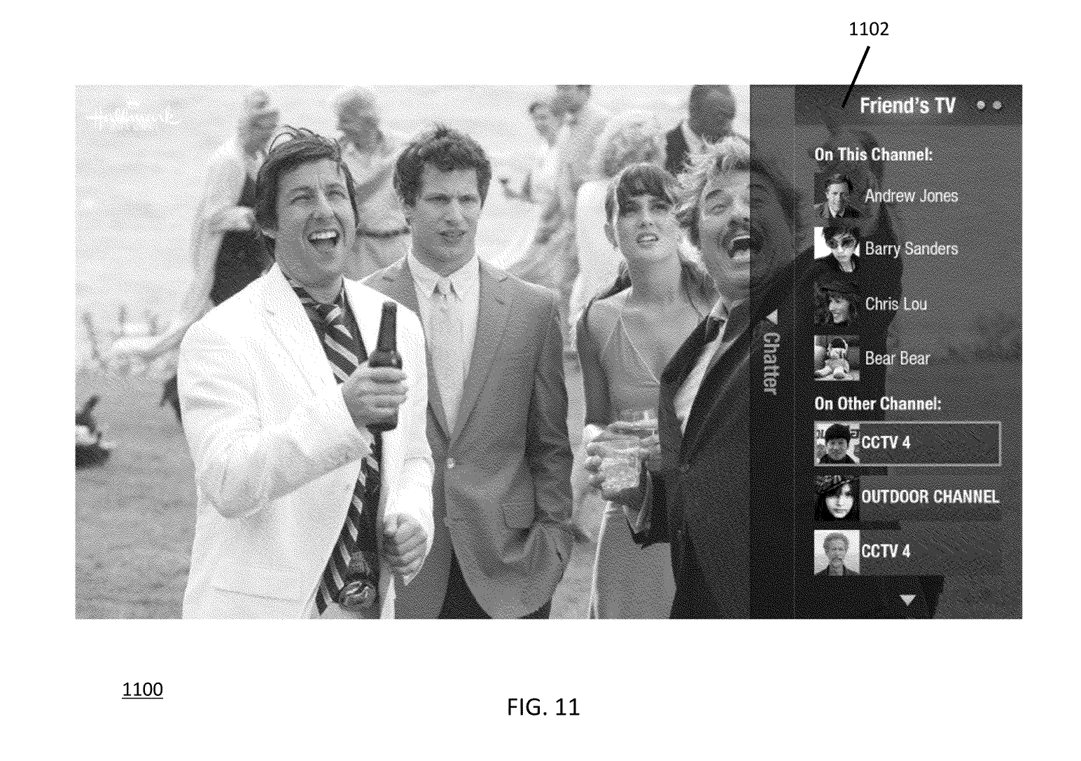

FIG. 11 is a diagram illustrating a third graphic user interface 1100 that allows a group-watch of a channel by different users in a virtual living room. The chat window 1002 can be changed to a friends-window 1102 that displays the contacts viewing the selected channel that is being hosted by the contact “Andrew Jones” (that is, the channel for which the contact “Andrew Jones” is a subscriber and is viewing the channel, while contacts of “Andrew Jones” are viewing the channel by virtue of being his contacts and irrespective of whether those contacts have subscribed to the channel). The friends-window 1102 can also display the contacts that are not viewing the selected channel that is being hosted by the contact “Andrew Jones,” and their presence status with respect to other channels that they are viewing. Further, the friends-window 1102 displays icons for those other channels being viewed by the contacts that are not viewing the selected channel.

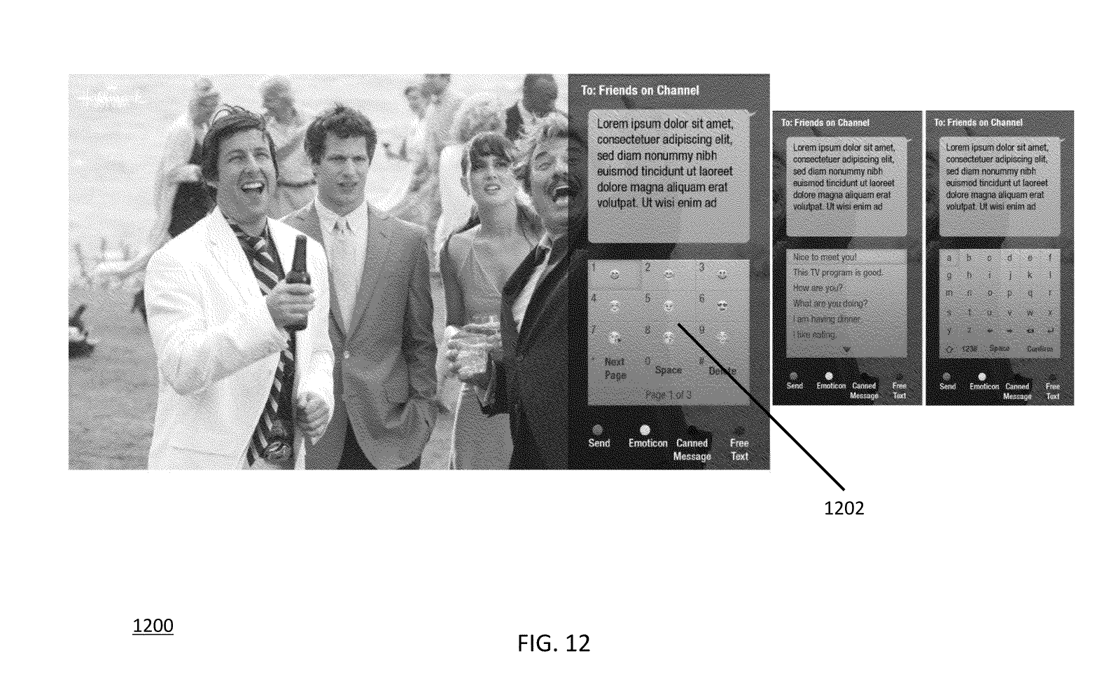

FIG. 12 is a diagram illustrating a third graphic user interface 1200 that allows a group-watch of a channel by different users in a virtual living room. With the remote control provided to the user, the user can send messages to one or more contacts. The user can send a single message to all contacts, or can individually select a contact and send messages to the selected contact. The window 1202 can provide different emoticons, which the user can select and insert within a message.

As noted above, the users that are connected and are viewing a same channel can communicate via text messages, audio messages, and/or video messages. More than two users can communicate with each other simultaneously, thereby forming a virtual living room where people can view a same channel and discuss about the viewed channel. For audio communication, the background noise can be reduced so that only voice and utterances are transmitted to contacts in the virtual living room.

The background noise in audio communication is reduced as noted below. When a user speaks, the audio signal is obtained at the set top box 120 of the user. The set top box 120 of the user then matches and extracts the differences between the original stream of the channel and the recorded audio signal, which can include the audio in the original stream and the voice message by the user. If a level of the differences is more than a threshold value (for example, 30 decibel, 40 decibel, 50 decibel, 70 decibel, or other threshold values), the recorded audio signal likely includes the voice message by the user rather than merely noise, and the set top box 120 of the user can transmit the recorded audio signal to other users. If the level of the differences is less than the threshold value, the audio signal likely includes merely noise, and the set top box 120 of the user does not transmit the recorded audio signal to other users over the network 116, such as internet. Such a prevention of transmission of noise saves bandwidth cost and preserves highest audio quality of the audio communication between users. Further, echo reduction and/or cancelling techniques can be employed in the set top boxes 120 and the microphone/speaker systems to eliminate or reduce (for example, minimize) echo resulting from the voices and utterances of one or more users in the room, as these voices and utterances can bounce back into the microphone.

The microphone system can include an array structure that can be implemented to maximize the signal to noise ratio within the virtual living room. The array structure can implement digital signal processing techniques. The microphone array structure can capture audio voices and utterances of the users that are both near and far from the microphone system. The microphone system can be deployed in the center of each room where the user is located. The array structure can be implemented as a strip of multiple microphones attached to the user device 118. In one implementation, the strip of microphones can run across the entire bottom of the user device 118 to form a sound bar. The microphones can communicate with one or multiple digital signal processors (DSPs). The DSPs provide for the ability to individually “steer” the reception of each of the microphones embedded in the microphone array strip to pick up the voices and utterances of different users that may be located in different places (for example, center, close to center, fringes, corners, and/or the like) in a room. The array can cover the expanse of the entire horizontal length or/and breadth of a face of the user device 118. The long length of the array allows a significant number of microphones to be used. Because of this significant number of microphones and because of these significant numbered microphones being in a straight line, the quality of the audio pickup is significantly better than conventional systems. Thus, the quality of audio heard at the one or more receiving ends of the virtual living room group is superior to that associated with conventional systems.

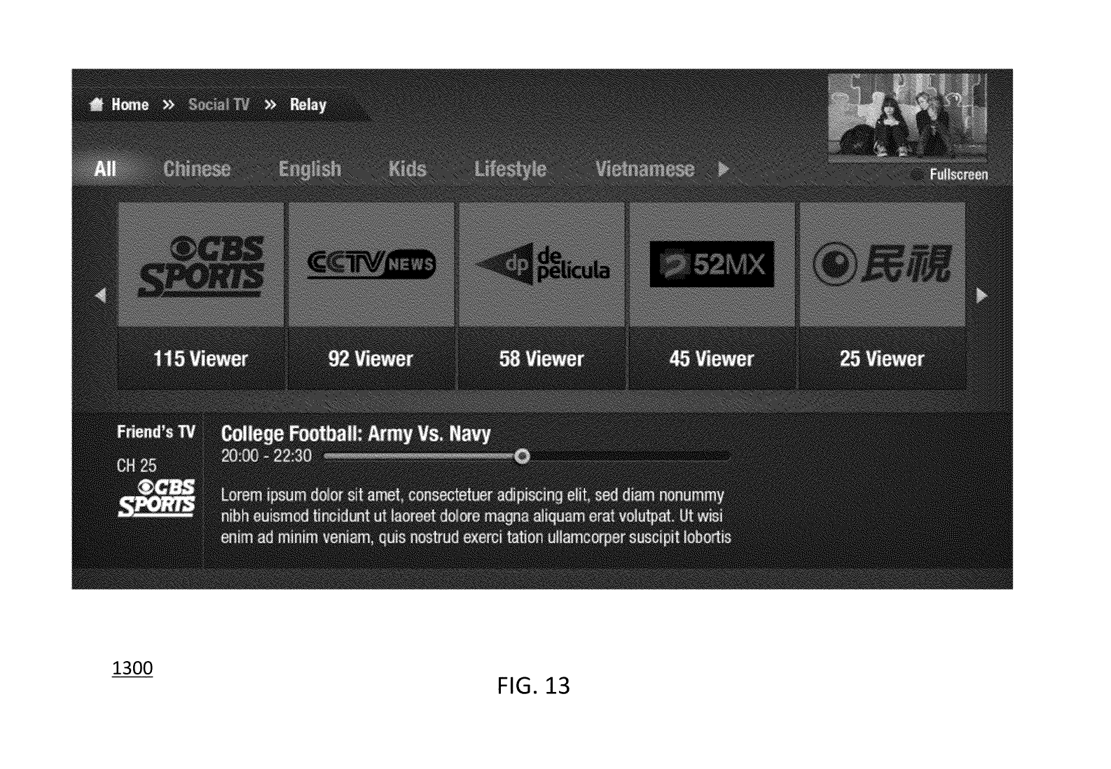

FIG. 13 is a diagram illustrating a third graphic user interface 1300 that displays channels available for a user. The graphical user interface 1300 displays icons of some popular channels. Each of these icons further displays a number of viewers viewing the channel. The graphical user interface 1300 displays icons of the channels in an order based on one or more of: preferences of the viewer, number of friends simultaneously viewing a particular channel, activity of conversations for each channel, keywords (describing the context of the content being watched) that can be pulled from the conversations, and other criteria. In one example, if a user generally views sports channels and discusses various sports with other contacts in virtual living rooms, the graphical user interface 1300 can display more sports channels followed by other channels associated with sports. Similarly, if another user often views cooking channels and discusses cooking techniques with other contacts in virtual living rooms, the graphical user interface 1300 can display more cookery channels followed by other channels associated with cooking.

In another implementation, the icons of the channels can be displayed on the graphical user interface 1300 in an order of popularity, which is characterized by the number of viewers currently viewing the channels. In some other implementations, the icons of the channels can be displayed on the graphical user interface 1300 in an order of popularity of a particular user based on a combination of number of viewers and their preferences—thus, the display of the icons can be different for each user in this implementation. In another implementation, the icons of the channels can be displayed on the graphical user interface 1300 in an alphabetical order of channel name or channel number. In yet another implementation, icons of the channels can be displayed on the graphical user interface 1300 based on number of previous views by the user.

The graphic user interface 1300 can further display premium channels that may be available for viewing to both subscribers (110, 112) and the non-subscriber 114. The user device 118 of the non-subscriber 114 can display the premium free channel to the non-subscriber 114 irrespective of whether any contact of the non-subscriber 114 is subscribed to the service and viewing the premium channel. Thus, the premium channels can always be available to any user. Such premium channels can encourage new users to view those premium channels, and eventually become subscribers to view other payment-requiring channels. The user can click on any premium channel displayed on the graphical user interface 1300, and join a common virtual living room that includes all the users viewing the premium channel. In some implementations, the user can optionally elect to communicate with only the contacts of the user who are in the virtual living room, and not with other viewers in the virtual living room. The service provider can manage the rights to the content of the displayed channel so that the non-subscriber can watch the channel for just a predetermined amount of time.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can be have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Other embodiments may be within the scope of the following claims.

What is claimed is:

1. A method comprising:
providing content of a video channel from a content server to a first user via a communication network;
receiving, by a management system connected to the content server, a request from a second user for the content of the video channel; and
providing the content of the video channel from the content server to the second user when the first user and the second user are determined to be associated as contacts or friends in a social network, the content of the video channel being provided to the second user until the content of the video channel is no longer provided to the first user.

2. The method of claim 1, further comprising:
preventing, by the management system, the content of the video channel from the content server from being provided to the second user based on real-time changes to a status of what the first user is currently watching and how long the second user has been watching the content of the video channel.

3. The method of claim 1, further comprising:
establishing, by the management system, a communication between the first user and the second user when the content of the video channel is being provided to the first user and the second user at substantially the same time.

4. The method of claim 1, wherein the video channel includes pre-programmed video content.

5. A method comprising:
transmitting a video channel to a first display device associated with a first subscriber of a service offering the video channel;
monitoring a presence status of the first subscriber via the first display device, the presence status characterizing a status of the first subscriber relative to the transmitted video channel;
transmitting the presence status to second display devices associated with one or more contacts of the first subscriber, the one or more contacts including at least one non-subscriber to the video channel;
enabling transmission of the video channel to the second display devices associated with the one or more contacts of the first subscriber, the transmission to the one or more contacts of the first subscriber being simultaneous to the transmission of the video channel to the first subscriber;
stopping transmission of the video channel to the second display device associated with the at least one non-subscriber to the video channel; and
providing a video channel purchase control to the second display device associated with the at least one non-subscriber, the video channel purchase control enabling the non-subscriber to subscribe to the service offering the video channel.

6. The method in accordance with claim 5, wherein the one or more contacts are online in a social network.

7. The method of claim 5, further comprising:
enabling a communication between the subscriber and the at least one non-subscriber when the video channel is being transmitted to the subscriber and the at least one non-subscriber.

8. The method of claim 5, further comprising:
synchronizing transmitting of the video channel to the subscriber and the at least one non-subscriber.

9. The method of claim 5, wherein the at least one non-subscriber is a contact with the subscriber via the social network.

10. The method of claim 5, wherein the presence status characterizes at least one of the following activities associated with the subscriber: viewing the video channel, not viewing the video channel for less than a threshold value of time, not viewing the video channel for more than the threshold value of time, and viewing another video channel.

11. A method comprising:
receiving a first request from a subscriber for access to a video channel from a display device via a communication network;
generating a group view token for the subscriber in response to the first request, the group view token characterizing information related to the channel being watched, the group view token comprising an identifier of the video channel or content of the video channel, and a location where the video channel or content is stored;
disseminating the group view token to one or more social network contacts of the subscriber via the communications network, the one or more social network contacts including at least one non-subscriber;
receiving a second request from the at least one non-subscriber for access to the video channel, the request including the group view token generated from the first request from the subscriber;
determining, via the group view token, the video channel or content of the video channel, and the location where the video channel or content is stored; and
enabling access to the location and content of the video channel by the non-subscriber.

12. The method of claim 11, wherein access of the video channel is not provided to the non-subscriber when the subscriber is not being transmitted the video channel for more than a threshold time.

13. The method of claim 12, wherein the non-subscriber is provided an option to subscribe to the video channel when the access to the video channel is not provided to the non-subscriber, the access of the video channel by the non-subscriber being restored when the non-subscriber uses the option to subscribe to the video channel.

14. The method of claim 11, wherein the video channel is transmitted simultaneously to the subscriber and the non-subscriber.

15. The method of claim 14, further comprising:
facilitating a communication between the subscriber and the non-subscriber when the channel is being displayed to the subscriber and the non-subscriber.

16. The method of claim 11, wherein the video channel is a television channel.

17. A system comprising:
a set top box at a location of a user, the set top box executing a client software application comprising one or more content libraries, a content-stream receiving component, a social user component, and an account management component, the content-stream receiving component receiving the content from the content libraries for play-back, the social user component determining a presence status of a user based on a viewing of the channel by the user, determining a subscription status characterizing whether the user is a subscriber, and determining a social network characterizing one or more social networking contacts of the user, the account management component receiving authentication data from the user;
a management system comprising a communication server and an account management server, the communication server receiving the presence status and the subscription status from the social user component, the account management server receiving the social network from the social user component, and receiving the authentication data from the account management component; and
a content server relaying content of the channel to the one or more content libraries based on the authentication data, the presence status, the subscription status, and the social network, the relayed content of the channel being displayed to the user.

18. The system of claim 17, wherein:
the client software application on the set top box is connected to the management system via a first network;
the client software application on the set top box is connected to the one or more content servers via a second network; and
the one or more content servers are connected to the management system via a third network.

19. The system of claim 18, wherein:
the first network and the second network are internet; and
the third network is intranet.

20. The system of claim 17, wherein the management system and the content server are implemented on separate computers.

21. The system of claim 17, wherein the communication server and the account management server are implemented on a same computer.

22. The system of claim 17, wherein the communication server and the account management server are implemented on separate computers.

23. The system of claim 17, wherein the communication server executes based on an extensible messaging and presence protocol (XMPP) protocol for communicating with the social user component.

24. The system of claim 17, wherein the account management server executes a representational state transfer (REST) software architecture that uses a hypertext transfer protocol secure (HTTPS) protocol.

25. The system of claim 17, wherein the client software application is provided to the user via a graphical user interface that receives the authentication data from the user and displays the content of the channel to the user.

26. The system of claim 17, wherein the displayed content of the channel comprises a plurality of channels that are ordered based on at least one of one or more preferences of the user and social interactivity of the user with the one or more social networking contacts.

27. The system of claim 17, wherein:
the social user component continuously determines the presence status of the user, the user being a subscriber;
the content server transmits the content to the subscriber and one or more non-subscribers that are contacts of the subscriber when the presence status indicates that the subscriber is viewing the channel, the content being transmitted and displayed simultaneously to the subscriber and the one or more non-subscribers; and
the content server stops transmitting the content to the non-subscribers when the presence status indicates that the subscriber is not viewing the channel.

28. The system of claim 26, further comprising:
a remote control device to facilitate communication between the subscriber and the one or more non-subscribers, the remote control device comprising:
a receiver of a microphone to receive voice signals of the subscriber during the communication;
a voice to text converter to convert at least a portion of the voice signals of the subscriber into corresponding text signals; and
a transmitter of the microphone to send the text signals to the communication server that sends the text signals to the one or more non-subscribers.

29. The system of claim 28, wherein the text signals sent to the one or more non-subscribers are displayed on at least one of: a webpage accessible to the one or more non-subscribers, and a graphical user interface of a client application executed on a set top box at a location of each of the one or more non-subscribers.

30. The system of claim 26, wherein the remote control device further comprises a social button that allows the user to toggle between a full screen viewing mode and a friends mode, the full screen viewing mode displaying the content of the channel on a full screen, the friends mode displaying the content of the channel and a list of contacts of the user that are viewing the content displayed to the user.
